(19) United States
(12) Patent Application Publication
(10) Pub. No.: US 2016/0359515 A1
(43) Pub. Date: Dec. 8, 2016

(54) CELL PHONE FIXING DEVICE OF CELL PHONE CASE

(71) Applicant: Chang Seob YOO, Seoul (KR)

(72) Inventor: Chang Seob YOO, Seoul (KR)

(21) Appl. No.: 15/170,688

(22) Filed: Jun. 1, 2016

(30) Foreign Application Priority Data
Jun. 2, 2015 (KR) 10-2015-0078221

(51) Int. Cl. H04B 1/3888; H04B 1/3883; H04B 1/3877

(52) U.S. Cl. CPC H04B 1/3888; H04B 1/3877; H04B 1/3883

(57) ABSTRACT

The present invention relates to a cell phone fixing device of a cell phone case that is provided with a connection member that is made of a thin material with high elasticity and no deformation in such a manner as to be mounted between cell phone side support members and cell phone front support members, so that cell phones having different sizes and thicknesses are tightly fixed to the support members through the single connection member, thereby reducing the thicknesses of the support members to achieve the slimming of the cell phone case, decreasing the number of parts and the number of assembling processes to achieve the reduction of the manufacturing cost, and permitting the cell phone underside support stand supporting the lower side portion of the cell phone to be moved to left and right sides to have no limitation in the use of a hole for a cell phone battery charging jack.

### BACKGROUND

Technical Field

The present invention relates to a cell phone fixing device of a cell phone case, and more particularly, to a cell phone fixing device of a cell phone case that is capable of fixedly accommodating cell phones having somewhat different sizes and thicknesses according to models of the cell phones into the cell phone case.

Background of the Related Art

With the rapid development of information and communication technologies, advanced technologies related to cell phones have been drastically improved day by day, so that cell phones having their peculiar functions have put on the market, while just having different sizes, thicknesses, and shapes.

Accordingly, cell phone cases in which the cell phones are mounted are manufactured correspondingly according to the sizes, thicknesses, and shapes of the models of cell phones and thus supplied to consumers.

As a result, manufacturers and sellers who supply the cell phone cases should have all models of cell phone cases corresponding to numerous models of cell phones, which is a burden to them, and whenever new models of cell phones are put on the market, further, the molds, parts, and stock products of the existing cell phone cases should be thrown away. Accordingly, molds, parts or products for the new models of cell phones have to be manufactured or purchased, which is also a burden to them. This raises the manufacturing costs, which is a burden to all of the manufactures, sellers and consumers.

On the other hand, if it is desired that the consumers who use the cell phones purchase cell phone cases, they should find and purchase the cell phone cases corresponding to their models of cell phones, which is very inconvenient for them.

Even if they purchase the cell phone cases corresponding to their models of cell phones, their cell phone may do not accurately correspond to their cell phone case according to product tolerances, so that the cell phones become too loosely mounted on the cell phone cases, thereby being easily separated and escaped from the cell phone cases, and contrarily, the cell phones become too fittedly mounted on the cell phone cases, thereby making it difficult to separate the cell phones from the cell phone cases upon the exchange of their battery.

So as to solve the above-mentioned problems, there is proposed Korean Patent No. 1278259 issued to the same applicant as the present invention and entitled ‘cell phone fixing device of cell phone case’. According to the conventional device, the above-mentioned problems are almost solved, but the cell phone fixing device for accommodating cell phones having different sizes and thicknesses into the cell phone case has a dual structure wherein the size of cell phone is fixed by means of a number of springs mounted on support members and the thickness of cell phone is fixed by means of two leaf springs mounted on the support members, so that undesirably, the thicknesses of the support members become high, thereby making it hard to achieve slimming of the cell phone case, and the number of parts and the number of assembling processes are all increased, thereby increasing the manufacturing cost.

Further, the conventional cell phone fixing device is configured wherein the two leaf springs are mounted on the support members to push the cell phone outwardly, thereby producing gaps between the cell phone and the support members to undesirably cause the thickness of the cell phone case to be high.

Additionally, the conventional cell phone fixing device is configured wherein a support member for supporting the underside of the cell phone is fixed to a given position of a support substrate, so that if the support member is located overlappedly on a hole for a cell phone battery charging jack, there is a limitation in mounting the cell phone on the cell phone case.

### SUMMARY OF THE DESCRIPTION

Accordingly, the present invention has been made in view of the above-mentioned problems occurring in the prior art, and it is an object of the present invention to provide a cell phone fixing device of a cell phone case that is capable of allowing cell phones having different sizes and thicknesses to be fixed to support members by means of single means for fixing cell phone size and thickness, thereby reducing the thicknesses of the support members to achieve the slimming of the cell phone case and decreasing the number of parts and the number of assembling processes to achieve the reduction of the manufacturing cost.

It is another object of the present invention to provide a cell phone fixing device of a cell phone case that is capable of allowing a cell phone underside support stand supporting the lower side portion of a cell phone to be moved to left and right sides, thereby having no limitation in the use of a hole for a cell phone battery charging jack.

To accomplish the above-mentioned objects, according to the present invention, there is provided a cell phone fixing device of a cell phone case, including: a support substrate having a connection member insertion recess and upper and lower guide grooves formed on the front surface thereof in a horizontal direction thereof; cell phone side surface support members having cell phone side support stands located on left and right side end portions thereof, guides adapted to be inserted into the upper and lower guide grooves, and guide grooves formed on left and right sides of the cell phone side support stands; cell phone front support members having cell phone front support stands located on the front surfaces thereof and guides adapted to be inserted into the guide grooves; a connection member made of a thin elastic material and disposed between the cell phone front supports, so that in a state where the connection member is seated into the connection member insertion recess of the support substrate, the guides are inserted into the guide grooves of the cell phone side support stands; and a front cover attached to the front surface of the support substrate.

According to the present invention, the cell phone fixing device of the cell phone case can allow the cell phones having different sizes and thicknesses to be tightly fixed to the support members through the single connection member, thereby reducing the thicknesses of the support members to achieve the slimming of the cell phone case, decreasing the number of parts and the number of assembling processes to achieve the reduction of the manufacturing cost, and permitting the cell phone underside support stand supporting the lower side portion of the cell phone to be moved to left and right sides to have no limitation in the use of a hole for a cell phone battery charging jack.

### BRIEF DESCRIPTION OF THE DRAWINGS

FIG. 1 is a perspective view showing a cell phone fixing device of a cell phone case according to the present invention.

FIG. 2 is a front, side and plane view showing the cell phone fixing device of a cell phone case according to the present invention.

FIG. 3 is an exploded perspective view showing the cell phone fixing device of a cell phone case according to the present invention.

FIG. 4 is a front, side and plane view showing the cell phone fixing device of a cell phone case according to the present invention, wherein a cell phone is mounted on the cell phone case by means of the cell phone fixing device.

### DETAILED DESCRIPTION

Hereinafter, an explanation on a cell phone fixing device of a cell phone case according to the present invention will be in detail given with reference to the attached drawing.

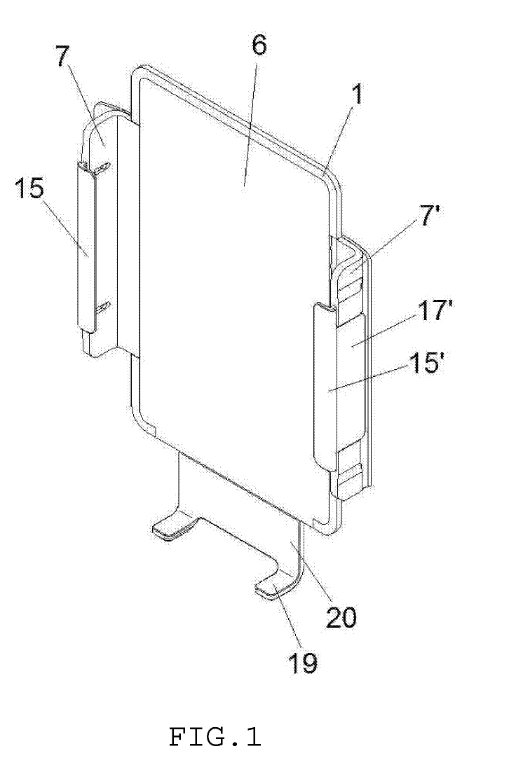

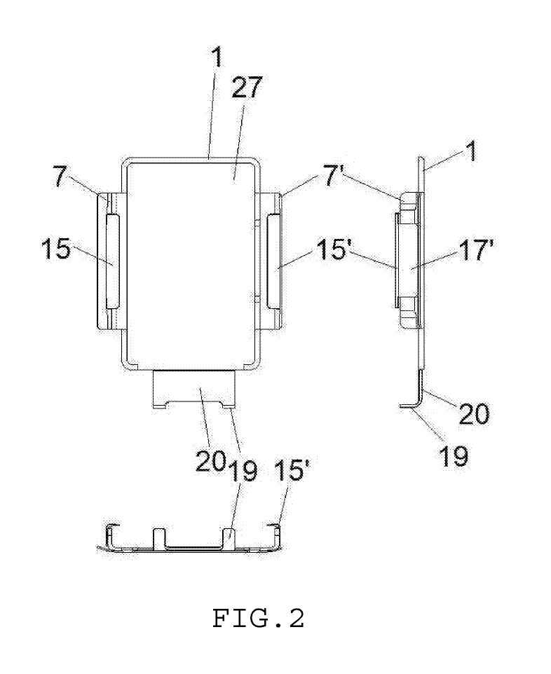

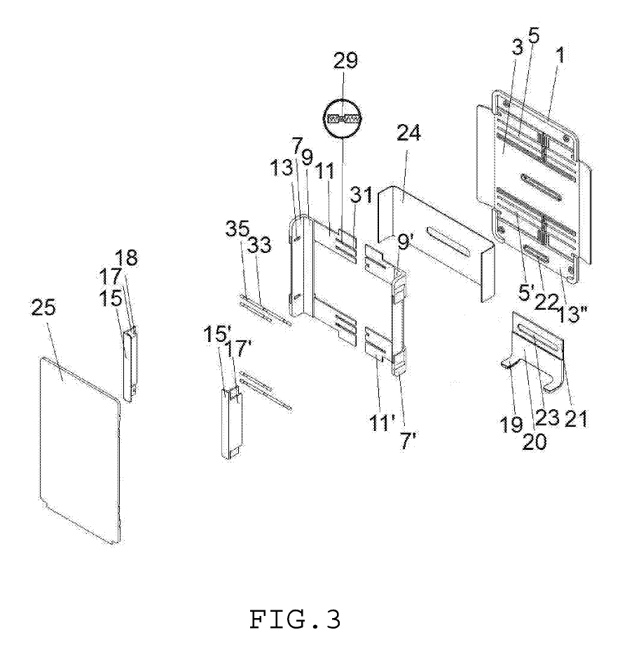

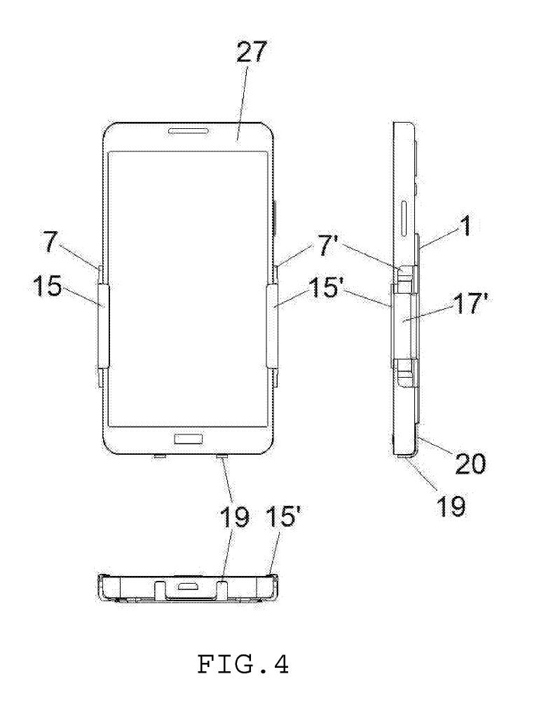

FIG. 1 is a perspective view showing a cell phone fixing device of a cell phone case according to the present invention, FIG. 2 is a front, side and plane view showing the cell phone fixing device of a cell phone case according to the present invention, FIG. 3 is an exploded perspective view showing the cell phone fixing device of a cell phone case according to the present invention, and FIG. 4 is a front, side and plane view showing the cell phone fixing device of a cell phone case according to the present invention, wherein a cell phone is mounted on the cell phone case by means of the cell phone fixing device.

A cell phone fixing device of a cell phone case according to the present invention, which is applicable to all of wallet, diary or cover types of cell phone cases, includes a support substrate 1 having a connection member insertion recess 3 and upper and lower guide grooves 5 and 5′ formed on the front surface thereof in a horizontal direction thereof and cell phone side surface support members 9 and 9′ having cell phone side support stands 7 and 7′ located on left and right side end portions thereof and guides 11 and 11′ adapted to be inserted into the upper and lower guide grooves 5 and 5′.

According to the present invention, further, the cell phone fixing device has guide grooves 13 formed on left and right sides of the cell phone side support stands 7 and 7′, and cell phone front support members 17 and 17′ having cell phone front support stands 15 and 15′ located on the front surface thereof and guides 18 and 18′ adapted to be inserted into the guide grooves 13.

Further, the cell phone fixing device includes a guide groove 13″ formed on the lower side portion of the support substrate 1 and a cell phone underside support member 20 having a cell phone underside support stand 19 formed on the lower end portion thereof and a guide 21 adapted to be inserted into the guide groove 13″ so that the cell phone underside support stand 19 is movable horizontally along a guide groove 23 formed on the guide 21.

On the other hand, the cell phone fixing device further includes a connection member 24 made of a thin material with high elasticity and disposed between the cell phone front supports 15 and 15′, so that in a state where the connection member 24 is seated into the connection member insertion recess of the support substrate 1, the guides 18 and 18′ are inserted into the guide grooves 13 of the cell phone side support stands 7 and 7′.

Further, the cell phone fixing device includes a front cover 25 attached to the front surface of the support substrate 1, so that a cell phone 27 is detachably attached to the front surface of the support substrate 1 and the inner surface of the cell phone case is attached to the back surface of the support substrate 1.

Furthermore, the cell phone fixing device includes spring insertion portions 31 formed on the upper and lower guide grooves 5 and 5′ of the support substrate 1 and on the guides 11 and 11′ of the cell phone side support members 9 and 9′, and the spring insertion portions 31 have support projections 29 formed on the end portion of the outer periphery thereof, so that locking projections 35 formed on springs 33 are locked on the support projections 29 in such a manner as to allow the elastic forces of the springs 33 to be maintained, thereby enabling the cell phone side support stands 7 and 7′ to be maintained with stronger elastic forces, together with the high elasticity connection member 24.

Further, the centers of the spring insertion portions 31 are moved to the right side, and otherwise, the number of springs 33 is increased on the left side, so that the elastic forces applied to the cell phone side support stands 7 and 7′ become stronger in the left side direction, thereby allowing the outer surface of the cell phone 27 mounted on the cell phone side support stands 7 and 7′ to always correspond to the right side surface of the cell phone case.

Under the above-mentioned configuration of the cell phone fixing device of the cell phone case according to the present invention, so as to mount the cell phone on the cell phone case, the top cover of the cell phone case is first open, and in the state where the cell phone 27 is located on the cell phone underside support stand 19, if the cell phone 27 is pushed between the cell phone side support stands 7 and 7′ of the cell phone side support members 9 and 9′, the guides 11 and 11′ of the cell phone side support members 9 and 9′ are slidingly moved horizontally along the upper and lower guide grooves 5 and 5′ of the support substrate 1, thereby allowing the cell phone 27 to be mounted between the cell phone side support stands 7 and 7′.

At this time, even if the size of the cell phone 27 is changed, it can be tightly fixed between the cell phone side support stands 7 and 7′ by means of the elastic force applied from the connection member 24 made of the thin material with the high elasticity and mounted between the cell phone side support stands 7 and 7′ of the cell phone side support members 9 and 9′.

At the same time, the guides 18 and 18′ of the cell phone front support members 17 and 17′ are slidingly moved horizontally in forward and backward directions along the guide grooves 13 of the cell phone side support stands 7 and 7′, and accordingly, the cell phone front support stands 15 and 14′ allow the cell phone 27 to be tightly fixed thereto in the forward and backward directions by means of the elastic force of the connection member 24, so that even if the cell phones 27 have different thicknesses, the cell phones 27 can be accommodated sufficiently into the cell phone front support stands 15 and 15′.

If the springs 33 are mounted on the cell phone side support members 9 and 9′, further, the cell phone side support stands 7 and 7′ can allow the cell phone 27 to be tightly fixed thereto with stronger elastic forces by means of the connection member 24 made of the elastic material and the springs 33.

Further, the centers of the spring insertion portions 31 are moved to the right side, and otherwise, the number of springs 33 is increased on the left side, so that the elastic forces applied to the cell phone side support stands 7 and 7′ become stronger in the left side direction, thereby allowing the outer surface of the cell phone 27 mounted on the cell phone side support stands 7 and 7′ to always correspond to the right side surface of the cell phone case.

On the other hand, if it is desired to separate the cell phone 27 from the cell phone case so as to exchange the battery of the cell phone 27, the reverse order to the order for mounting the cell phone 27 on the cell phone case is carried out. First, the left side cell phone front support stand 15 somewhat pushes to the left side, and accordingly, the left side cell phone front support stand 15 and the left side cell phone side support stand 7 are moved outwardly and open along the upper and lower guide grooves 5 and 5′ by means of the connection member 24 and the springs 33, so that the cell phone 27 is simply separated from the cell phone side support members 9 and 9′ and the cell phone front support members 17 and 17′.

After the separation of the cell phone 27, the cell phone side support members 9 and 9′ and the cell phone front support members 17 and 17′ are moved again inwardly and backwardly by means of the restoring forces of the connection member 24 and the springs 33 and thus maintained at the compressed states.

According to the present invention, therefore, the cell phone fixing device of the cell phone case is configured wherein the connection member 24 is made of the thin material with the high elasticity and no deformation in such a manner as to be mounted between the cell phone front support members 15 and 15′ and the cell phone front support members 17 and 17′, so that even if the cell phones have different sizes and thicknesses, the cell phone 27 can be tightly fixed to the cell phone side support members 9 and 9′ and the cell phone front support members 17 and 17′ through the single connection member 24, thereby allowing the thicknesses of the support members to be reduced to achieve the slimming of the cell phone case, decreasing the number of parts and the number of assembling processes to achieve the reduction of the manufacturing cost, and permitting the cell phone underside support stand 19 supporting the lower side portion of the cell phone 27 to be moved to left and right sides to have no limitation in the use of a hole for a cell phone battery charging jack.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. For example, the shapes and coupling structures of the connection member 24, the springs 33, the cell phone side support members 9 and 9′, the cell phone front support members 17 and 17′, and the cell phone underside support member 20 may be changed appropriately without departing from the scope and spirit of the present invention.

What is claimed is:

1. A cell phone fixing device of a cell phone case, comprising:
a support substrate having a connection member insertion recess and upper and lower guide grooves formed on the front surface thereof in a horizontal direction thereof;
cell phone side surface support members having cell phone side support stands located on left and right side end portions thereof, guides adapted to be inserted into the upper and lower guide grooves, and guide grooves formed on left and right sides of the cell phone side support stands;
cell phone front support members having cell phone front support stands located on the front surfaces thereof and guides adapted to be inserted into the guide grooves;
a connection member made of a thin elastic material and disposed between the cell phone front supports, so that in a state where the connection member is seated into the connection member insertion recess of the support substrate, the guides are inserted into the guide grooves of the cell phone side support stands; and
a front cover attached to the front surface of the support substrate.

2. The cell phone fixing device according to claim 1, further comprising:
a guide groove formed on the lower side portion of the support substrate; and
a cell phone underside support member having a cell phone underside support stand formed on the lower end portion thereof and a guide adapted to be inserted into the guide groove, the guide having a guide groove formed thereon, so that the cell phone underside support stand is movable horizontally along the guide groove formed on the guide.

3. The cell phone fixing device according to claim 1, wherein the upper and lower guide grooves of the support substrate and on the guides of the cell phone side support members have spring insertion portions formed thereon in such a manner as to have support projections formed on the end portion of the outer periphery thereof, so that locking projections formed on springs are locked on the support projections, thereby maintaining the elastic forces of the springs.

4. The cell phone fixing device according to claim 3, wherein the centers of the spring insertion portions are moved to the right side, and otherwise, the number of springs is increased on the left side, so that the elastic forces applied to the cell phone side support stands become stronger in the left side direction, thereby allowing the outer surface of the cell phone mounted on the cell phone side support stands to always correspond to the right side surface of the cell phone case.
